(19) United States
(12) Patent Application Publication
(10) Pub. No.: US 2024/0083775 A1
(43) Pub. Date: Mar. 14, 2024

(54) SUPERSONIC PURIFICATION OF WATER AND APPARATUS THEREFOR

(71) Applicant: NATURAL ENVIRONMENT R&D, LLC, Midland, TX (US)

(72) Inventor: Brian TANG, Dallas, TX (US)

(73) Assignee: NATURAL ENVIRONMENT R&D, LLC, Midland, TX (US)

(21) Appl. No.: 18/261,527

(22) PCT Filed: Jan. 19, 2022
(86) PCT No.: PCT/US2022/012858

§ 371 Date: Jul. 14, 2023

Related U.S. Application Data
(60) Provisional application No. 63/139,390, filed on Jan. 20, 2021.

(51) Int. Cl. C02F 1/12; B01D 1/00; B01D 1/14; B01D 1/16; B01D 5/00

(52) U.S. Cl. CPC C02F 1/12; B01D 1/0017; B01D 1/14; B01D 1/16; B01D 5/006; C02F 2101/30

(57) ABSTRACT

Water purification may occur by introducing sufficient heat into a standing fluid wave produced by supplying impure water into a supersonic gas stream. At least partially purified water may be recovered in the form of steam and undergo condensation into liquid water thereafter. Such water purification methods may comprise: generating a supersonic gas stream by feeding a gas through a shockwave nozzle under conditions sufficient to achieve a supersonic velocity, supplying impure water into the supersonic gas stream to produce a standing fluid wave comprising atomized water droplets downstream from an exit end of the shockwave nozzle, introducing sufficient heat into the standing fluid wave to cause at least a portion of the atomized water droplets to phase change into steam, and obtaining the steam as an overhead stream separated from an effluent stream containing one or more contaminants.

### BACKGROUND

Although water is widely available over much of the earth, clean water is a much more precious resource to come by. Expensive, time-consuming and/or energy-intensive processes are often needed to remediate an impure water source to afford a contaminant profile sufficient to support an intended application or process, especially when starting from a highly impure water source. Reaching a contaminant level adequate to permit human consumption may be more problematic still. In addition, sufficient throughput to support large-scale purification may likewise be an issue in many water purification processes. While many water purification processes are available, none are ideal and widely applicable to a range of impure water types. Distillation processes, for example, are extremely energy intensive and may suffer from throughput issues. Membrane separation processes likewise may be capable of forming highly purified water, but membranes may be especially prone to surface fouling or pore occlusion when remediating highly impure water sources.

A wide array of contaminants may be present in impure water obtained from various sources, including organic chemicals (e.g., oil components, solvents, and the like), inorganic chemicals (e.g., salts, heavy metals, radionuclides and the like), biologicals (e.g., algae, bacteria, other microorganisms, and the like), and any combination thereof. Contaminants may be present in water in a suspended state or a dissolved state, including dissolved solids, liquids and gases.

Impure water is encountered in many industrial and natural settings. Without limitation, industrial wastewater may be generated in mining operations, oilfield operations (e.g., drilling and production), paper and textile manufacturing, chemical and commercial product manufacturing, and the like. Vast quantities of industrial wastewater (e.g., millions of gallons) in need of remediation may be generated in many instances. Similarly, many naturally occurring water sources have insufficient purity to support further use without undergoing significant purification, such as ground water, sea water, river water, lake water, brackish water, and the like. Municipal wastewater, including black water and gray water, may also require significant remediation before again becoming fit for human consumption or being discharged.

In addition to the need for remediating an impure water source, effective water sourcing and management of large quantities of impure water may be especially important in some applications. For example, during drilling, production and other operations in the oilfield, vast quantities of water are often produced from a wellbore, either separately from or concurrent with a hydrocarbon resource. The produced water may arise from naturally occurring ground water or from aqueous treatment fluids introduced into a wellbore to facilitate drilling or production. Regardless of origin, the produced water is often heavily laden with contaminants and may need to be stored before undergoing remediation. Storage and transport of large produced water volumes may create significant logistical challenges for a well operator. Indeed, one common method for disposing of excess water in the oilfield is to drill one or more additional wells for returning the impure water downhole. Drilling such disposal wells may significantly add to production costs, and accommodation of all of the excess water in need of disposal may not be possible in some cases. Similar storage and transport issues for large volumes of impure water may be encountered in other industries as well.

As mentioned above, vast quantities of impure water are often produced in the oilfield. In addition to the produced water, large quantities of relatively pure water are also needed for formulating treatment fluids used in conjunction with drilling or producing a wellbore. As used herein, the terms “treat,” “treatment,” “treating,” and grammatical equivalents thereof refer to any subterranean operation that uses a fluid in conjunction with achieving a desired function and/or for a desired purpose. Unless otherwise specified, use of these terms does not imply any particular action by a treatment fluid or a component thereof. In order for a treatment fluid to function in an intended manner, the water source used for its formulation may need to meet a specified contaminant profile, such as to promote a desired gelation rate, provide a particular weight/density, or the like. Although significant quantities of produced water may be present at a job site, the produced water may lack a contaminant profile sufficient to facilitate reuse of the produced water in a treatment fluid. As a result, sourcing and transport of large quantities of sufficiently pure water to a job site represent additional problematic and costly logistical challenges for a well operator. At present, there are limited options available for effectively remediating produced water at a job site in a high-throughput manner. Similar difficulties may be encountered in other industrial and municipal processes generating large quantities of wastewater.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, as will occur to one of ordinary skill in the art and having the benefit of this disclosure.

FIG. 1 shows a diagram of a water purification apparatus of the present disclosure, positioned in a substantially horizontal orientation.

FIG. 2 shows a diagram of a water purification apparatus of the present disclosure, positioned in a substantially vertical orientation.

### DETAILED DESCRIPTION

The present disclosure generally relates to remediation of impure water and, more particularly, methods and apparatuses for remediating impure water utilizing shockwave technology.

As discussed above, impure water containing a range of contaminants may be obtained from various industrial and natural sources, sometimes in rather large quantities. Remediation of impure water to provide a contaminant profile sufficient to support an intended application can be a challenging task and may be expensive, time-consuming, energy-intensive and/or throughput-limited. Management of large quantities of impure water at a job site can oftentimes be logistically challenging. In the oilfield services industry, for example, sourcing and transport of relatively pure water to a job site and disposal or remediation of impure water at the job site may represent a significant fraction of the cost of drilling and producing a well. Similar considerations may also apply in other industries generating large quantities of impure water.

Although various techniques are available for remediating an impure water source, currently available techniques present limitations that may limit their economic feasibility and/or throughput, particularly when processing massive quantities of impure water in a field environment. Advantageously, the present disclosure provides energy-efficient, high-throughput and cost-effective methods and apparatuses for remediating various sources of impure water. State-of-the-art distillation systems may consume approximately 1.5-2 MBTUs per hour to afford a water recovery rate of about 1 gallon per minute (gpm). In comparison, the methods and apparatuses of the present disclosure may be operated to provide a water recovery rate of about 2-2.5 gpm at a much lower estimated energy consumption level of approximately 0.5-0.7 MBTUs per hour. The energy required to produce compressed gas is not accounted for in the energy consumption levels of the presently described methods and apparatuses. By way of non-limiting example, heat levels in the 0.5-0.7 MBTUs per hour range provided from a burner flame, for example, are not significantly different from multiple natural gas or propane burners employed in common outdoor cooking equipment. It is particularly surprising that relatively small amounts of added heat can result in vaporization of such large quantities of water. As an added benefit, the methods and apparatuses of the present disclosure may be carried out or deployed readily in a field environment. Further, the methods and apparatuses of the present disclosure may be used in conjunction with or to supplement a variety of industrial processes in which impure water is obtained or generated. Various types of impure water having a wide range of contaminant profiles may be addressed through use of the disclosure herein.

In particular, the present disclosure provides methods and apparatuses in which impure water is supplied into a supersonic gas stream to facilitate separation of the water from one or more contaminants present therein. As used herein, the term “supersonic” refers to a medium (e.g., a gas) accelerated to a velocity exceeding the local speed of sound. Once impure water has been introduced into the supersonic gas stream, atomized water droplets form therein and travel as a standing fluid wave. The atomized water droplets may readily absorb heat, supplied from an external heat source located adjacent to the standing wave, and phase change into steam, which may facilitate separation from one or more contaminants remaining in a non-volatile effluent stream. Advantageously, the liquid water obtained following condensation of the steam may have a very high purity, comparable in quality to that obtained by distillation, and may have a sufficient contaminant profile to facilitate onsite recycling of the water in several manners. For example, impure water processed according to the disclosure herein may be satisfactory for forming certain types of subterranean treatment fluids, thereby avoiding having to source and transport pure water to a job site. Other industrial processes may similarly benefit from application of the disclosure herein. Unexpectedly, the contaminant profile of the effluent stream produced according to the disclosure herein may also be significantly improved compared to competing processes, likely due to pyrolysis or decomposition of organics and biologics upon efficient addition of heat to the supersonic gas stream.

Supersonic gas streams may be readily produced by introducing a compressed gas under specified conditions to a shockwave nozzle, such as those described in U.S. Pat. Nos. 7,842,264 and 9,254,472, each of which is incorporated herein by reference in its entirety. Shockwave nozzles, also known as de Laval nozzles or convergent-divergent nozzles, are commonly used in the aerospace industry to provide rocket propulsion and will be familiar to one having ordinary skill in the art. By providing a gas at a sufficient pressure and mass flow, a subsonic gas stream passing through a shockwave nozzle may accelerate to a supersonic velocity downstream of a pinch point located therein. The kinetic energy of molecules within the supersonic gas stream may lead to high-energy collisions for promoting chemical reactions in the supersonic gas stream, as described in the foregoing U.S. Patents. Although some chemical reactions occurring in the supersonic gas stream may be exothermic, they do not lead to significant heating, particularly heating to an extent necessary for converting liquid water into steam.

In the present disclosure, impure water undergoes immediate and complete or near-complete conversion into a plurality of atomized water droplets in the form of a standing fluid wave within a supersonic gas stream. The standing fluid wave arises as a direct consequence of accelerating a gas stream to a supersonic speed using a shockwave nozzle. Within the standing fluid wave, the atomized water droplets may absorb heat provided from an external heat source with exceptional efficiency, such that a phase change of the water into steam takes place. Advantageously, the standing fluid wave provides a predictable geometry for introduction of sufficient heat thereto for promoting water vaporization. Without a predictable geometry being realized through formation of a standing fluid wave, it can be difficult to mechanically achieve sufficient heat contact for promoting heat transfer to water. As a further benefit, the geometry of the standing fluid wave may be altered through modification of the shockwave nozzle design to vary the heat transfer properties in a manner necessary for a given application. Although exothermic chemical reactions may continue to take place within the standing fluid wave due to high kinetic energy collisions, the amount of heat generated from chemical reactions alone is generally insufficient to promote steam formation, as in supersonic gas stream processes for promoting a chemical reaction, discussed above. Without the introduction of additional heat from an external heat source, no phase change occurs, and impure water may be recovered after the atomized water droplets coalesce together. Advantageously, the supersonic gas stream exiting the shockwave nozzle creates a Venturi effect, which pulls the externally applied heat into the standing fluid wave with high selectivity. As a result, very little applied heat is lost to the surroundings, and the heat captured by the standing fluid wave may be used efficiently for promoting steam formation. In addition, the atomized water droplets within the standing fluid wave may absorb energy more efficiently than can bulk water during distillation processes, likely due to their high surface area and coupled with the efficient input of heat to the standing fluid wave. Thus, the methods and apparatuses of the present disclosure are advantageous compared to distillation processes in terms of their efficiency and speed. Further, the methods and apparatuses of the present disclosure are readily scalable as needed for processing the volume of impure water present at a particular location. Moreover, apparatuses capable of processing impure water according to the disclosure herein may be readily transportable to remote job sites and require minimal resources for operation once deployed, as described further herein.

The methods and apparatuses of the present disclosure may be incorporated within any application requiring a source of relatively pure water and/or generating significant volumes of impure water. By utilizing the methods and apparatuses of the present disclosure in this manner, water sourcing, management, and disposal or reuse issues may be more effectively addressed than with conventional water remediation processes. Particular advantages may be realized within applications generating large volumes of impure water that may otherwise be problematic to manage and/or expensive or problematic to remediate due to the location where the impure water is generated. Impure water produced in the oilfield is but one example. Advantages over the large size of traditional distillation apparatuses and other water purification equipment may also be realized through use of the disclosure herein. As such, the methods and apparatuses of the present disclosure may be advantageously incorporated within any oilfield operation, particularly to supply an on-site source of relatively pure water for forming a treatment fluid. In addition, various applications utilizing a source of relatively pure steam may also be supported through utilization of the methods and apparatuses described herein.

Accordingly, water purification methods of the present disclosure may comprise: generating a supersonic gas stream by feeding a gas through a shockwave nozzle under conditions sufficient to achieve a supersonic velocity; supplying impure water containing one or more contaminants into the supersonic gas stream to produce a standing fluid wave comprising atomized water droplets downstream from an exit end of the shockwave nozzle; introducing sufficient heat into the standing fluid wave to cause at least a portion of the atomized water droplets to phase change into steam; and obtaining the steam as an overhead stream separated from an effluent stream comprising at least a portion of the one or more contaminants.

Shockwave nozzles suitable for generating a supersonic gas stream may comprise an entry end and an exit end adjoined with a body having a pinch point. Sub-sonic gas flow to the entry end of the shockwave nozzle may take place under pressure and mass flow conditions sufficient to afford acceleration of the gas to a supersonic velocity downstream from the pinch point. Depending on the particular shockwave nozzle design, the introduction pressure for a gas to the shockwave nozzle needed to produce a supersonic velocity downstream from the pinch point may be varied. Similarly, the shape and spread of the standing fluid wave may be varied through alteration of the shockwave nozzle design. Suitable pressures and mass flow conditions to afford a supersonic gas stream exiting a particular shockwave nozzle may be readily identified by one having ordinary skill in the art.

The gas introduced to the shockwave nozzle to generate the supersonic gas stream may be an inert gas, such as air, nitrogen, or a noble gas (e.g., helium, argon, neon, krypton, or the like). Noble gases may be less desirable due to their higher cost. Preferably, nitrogen, air, or any combination thereof may comprise the supersonic gas stream. Compressed air, for example, may comprise primarily nitrogen (78 vol. %) and oxygen (21 vol. %), along with less than 1 vol. % total of other gases such as argon, and carbon dioxide on dry basis. Wet air may comprise up to 1% water vapor.

Impure water may be supplied into the supersonic gas stream in pulses or, preferably, as a continuous stream or continuous spray of discontinuous water droplets. The rate of introduction of impure water into the supersonic gas stream may be selected to afford efficient use of energy and provide good contacting properties. If the rate of introduction is too small, the energy efficiency may be poor. Introduction rates that are too high, in contrast, may overcome shock dynamics and not result in atomization of the impure water in the form of water droplets. Thus, the rate of introduction of impure water may be maintained at or below a rate at which atomization of the impure water takes place. The amount of water introduced to the standing fluid wave may also be impacted by the standing wave geometry exiting a particular shockwave nozzle. In illustrative embodiments, the rate of introduction to the standing fluid wave from one shockwave nozzle may range from about 0.5 gpm (gallons per minute) to about 10 gpm, or about 0.5 gpm to about 3 gpm, or about 1 gpm to about 5 gpm, or about 2 gpm to about 10 gpm, or about 3 gpm to about 7 gpm, or about 6 gpm to about 10 gpm. Apparatuses containing multiple shockwave nozzles in parallel may process a volume of water n times these rates of introduction per minute, wherein n is the number of shockwave nozzles in parallel.

The standing fluid wave may be produced within a shockwave tube that is operably connected to the exit end of the shockwave nozzle. The shockwave tube may be insulated and limit intake of ambient atmosphere into the standing fluid wave. Intake of ambient atmosphere into the standing fluid wave may limit intake of heat from the heat source into the standing fluid wave and possibly preclude sufficient heat absorption to afford a phase change of the impure water into steam. The shockwave tube may have a diameter that is larger than the width of the standing fluid wave. Depending on design of the shockwave nozzle and the geometry of the standing fluid wave resulting therefrom, suitable diameters of the shockwave tube may range from about 1 foot to about 6 feet. Similarly, the length of the shockwave tube may range from about 3 feet to about 15 feet. The shockwave tube may have a length that is at least long enough to introduce sufficient heat for promoting the phase change into steam. Likewise, the shockwave tube may have a maximum length such that minimal steam condenses to liquid water before exiting the shockwave tube. A heat source used to promote heating of the standing fluid wave may be operably connected to the shockwave tube and/or located within the shockwave tube in particular embodiments, as discussed hereinafter.

Heat may be introduced into the standing fluid wave using any heat source capable of supplying sufficient heat to convert the atomized water droplets into steam. The heat source may be positioned adjacent to the standing fluid wave to accomplish the foregoing. The term “adjacent,” as used with respect to the heat source, refers to any position sufficiently close to the standing fluid wave to facilitate heat transfer thereto, but not within the standing fluid wave itself. In illustrative embodiments, the heat source may be about 1 foot or less from an edge of the standing fluid wave, although disposition of the heat source a longer distance away may be possible in some process configurations. A burner flame located at this distance, for example, may project into the standing fluid wave to promote heat transfer. Similarly, an electric heating element at this distance may be sufficiently close to deliver heat radiatively into the standing fluid wave. The heat source may be positioned at any location concurrent with or downstream from the location where impure water is supplied to the supersonic gas stream, such as adjacent to the exit end of the shockwave nozzle.

Suitable heat sources may include, for example, a burner or an electric heating element. A flame from the burner may project into the standing fluid wave to promote direct heating of the atomized water droplets. Alternately, a burner flame may remain outside the standing fluid wave and radiate heat into the standing fluid wave to promote heating, as further aided by the Venturi effect. Similarly, an electric heating element may be located adjacent to the standing fluid wave for promoting indirect heating, as aided by the Venturi effect.

The impure water may be introduced into the supersonic gas stream at any location upstream from the heat source or concurrent with the heat source. In particular embodiments, the impure water may be introduced into the shockwave nozzle adjacent to the exit end or into the shockwave tube upstream or concurrent with the heat source. Preferably, introduction of the impure water into the supersonic gas stream may take place at a location downstream from the exit end of the shockwave nozzle, particularly within the shockwave tube.

Once sufficient heat has been introduced into the standing fluid wave, at least a portion of the impure water may be converted into steam, and the steam may be obtained as an overhead stream, such that the steam is separated from the one or more contaminants. An effluent stream comprising at least a portion of the one or more contaminants may be obtained as well. The effluent stream may be a bottoms stream comprising an aqueous concentrate comprising at least a portion of the one or more contaminants. Alternately, the effluent stream may be obtained as a sludge, depending on the amount of residual water present therein. The amount of water recovered as steam from the impure water may be about 35 vol. % or greater, or about 50 vol. % or greater, or about 70 vol. % or greater, or about 90 vol. % or greater.

Depending on particular process considerations, a shockwave tube operably connected to the shockwave nozzle may be oriented horizontally, vertically, or at any angle in between these two extremes. Steam may be obtained as an overhead stream of the shockwave tube in either orientation. In a horizontal orientation, the effluent stream may gather upon a bottom interior surface of the shockwave tube and gradually drain from an exit end opposite the location where the shockwave tube is operably connected to the shockwave nozzle. The shockwave tube may be angled slightly downward, such as at an angle deviating about −5 degrees to about −30 degrees, or about −5 degrees to about −20 degrees, or about −10 degrees to about −15 degrees with respect to true horizontal, in order to promote drainage of the effluent stream. In a vertical or near-vertical orientation, the effluent stream may drain downward and bypass the shockwave nozzle, while the steam again exits the shockwave tube as an overhead stream. The supersonic gas stream exiting the shockwave nozzle may preclude the effluent stream from draining into the shockwave nozzle in a substantially vertical orientation.

Once the steam has been obtained and at least partially separated from the one or more contaminants, the steam may be collected for recovery of the water. Optionally, the steam may be condensed as liquid water, such as by passing the steam through a heat exchanger. The excess heat removed from the steam may further optionally be supplied to a parallel process in which heating is needed, such as for reboiler heating in a coupled chemical production process. The impure water supplied to the supersonic gas stream may be obtained from the parallel process or from another source. As discussed further below, the impure water may be obtained from an oilfield or various processes conducted in an oilfield, such as drilling a wellbore or treating a wellbore to facilitate production of a hydrocarbon resource therefrom.

The steam obtained in accordance with the foregoing may be sufficiently pure to facilitate reuse thereof, either as liquid water or directly as a vapor, in many instances. If further purification is desired, the steam may be condensed as liquid water, and the liquid water may be reintroduced to the supersonic gas stream. The liquid water may be reintroduced to the supersonic gas stream in combination with impure water that has not yet been purified, or the liquid water may be reintroduced for additional purification separately from impure water that has not yet undergone purification. Reintroduction of the liquid water may take place within a continuous stream, or the liquid water may be pooled and repurified batchwise once a sufficient volume has been collected. Thus, in some instances, feeding of impure water may be discontinued while reintroducing liquid water for additional purification in accordance with the foregoing. In another alternative process configuration, the liquid water may be reintroduced to a supersonic gas stream produced with a second shockwave nozzle, such that series purification of the water may be realized. In a series configuration, the liquid water may be continuously introduced to the supersonic gas stream produced from the second shockwave nozzle. Further alternately, steam produced from a first standing fluid wave may be reintroduced to a supersonic gas stream produced from a second shockwave nozzle without being condensed to liquid water first. The added heat of the steam may enhance vaporization performance within the supersonic gas stream produced from the second shockwave nozzle.

Further alternately, the steam may be supplied to a parallel process in need of a supply of relatively pure steam, without undergoing condensation to form liquid water. For example, the steam may be fed to a steam cracking reactor in some process implementations.

Sources of impure water that may undergo purification according to the disclosure herein are not believed to be particularly limited. The impure water may contain organic contaminants, inorganic contaminants, biological contaminants, or any combination thereof. Some organic contaminants may undergo pyrolysis upon introducing sufficient heat into the standing fluid wave, therefore becoming separated from the steam without entering the effluent stream. Non-pyrolyzed organic contaminants, in contrast, may be recovered in the effluent stream. Biological contaminants may similarly become inactivated and possibly undergo pyrolysis under heating conditions. In contrast, many inorganic contaminants, particularly salts, heavy metals, and the like are not totally degradable under heating conditions and do not boil rapidly. Upon forming steam, the inorganic contaminants too may be separated from the steam, such that at least partially purified liquid water is obtained following condensation of the steam, and at least a portion of the inorganic contaminants are concentrated within the effluent stream. Residual organic and/or biological contaminants may likewise be separated from the water during steam production and subsequent condensation.

In some instances, it may be desirable to recover one or more contaminants from the effluent stream, since certain contaminants may have value in their own right, such as transition metals and rare earth metals. Techniques to isolate a given contaminant from a plurality of other contaminants in an aqueous effluent will be familiar to one having ordinary skill in the art.

Particular sources of impure water suitable for purification according to the disclosure herein include, for example, produced water, ground water, salt water, sea water, brine, brackish water, fresh water, mining water, industrial waste water, municipal waste water, spent oilfield treatment fluids, gray water, black water, and any combination thereof. As used herein, the term “gray water” refers to waste water from sinks, baths, washing machines, dishwashers and the like from homes and commercial sources. As used herein, the term “black water” refers to water contaminated with urine and/or sewage. As used herein, the term “brine” refers to a saturated aqueous salt solution, and the term “salt water” refers to a non-saturated aqueous salt solution. As used herein, the term “brackish water” refers to a water having a salinity greater than that of fresh water but less than that of sea water. The term “ground water” refers to water released from a subterranean formation or aquafer through a spring or upon drilling a well. The term “produced water” refers to any water obtained from a wellbore penetrating a subterranean formation. The produced water may be ground water, ground water co-produced with a spent or partially spent subterranean treatment fluid, a spent or partially spent oilfield treatment fluid (i.e., water originating from a subterranean treatment fluid injected into a wellbore and subsequently produced), or any combination thereof.

Treatment fluids may be employed in a variety of subterranean treatment operations to facilitate or promote a particular action within the subterranean formation, either during drilling or during production. Methods for conducting a subterranean treatment operation may comprise obtaining liquid water in at an least partially purified form according to the disclosure herein, formulating the liquid water into a treatment fluid, and introducing the treatment fluid into a wellbore penetrating a subterranean formation. If needed, the liquid water may be tested to ensure it has a contaminant profile sufficient for formulating a given type of treatment fluid and/or the liquid water may be repurified in accordance with the disclosure above. Treatment fluids that may be formulated in accordance with the disclosure herein and employed in the corresponding treatment operations include, but are not limited to, drilling fluids, stimulation fluids, production fluids, remediation fluids, sand control fluids, fracturing fluids, gravel packing fluids, acidizing fluids, descaling fluids, consolidation fluids, workover fluids, cleanup fluids, and the like. A water-miscible co-solvent may be combined with the water in the treatment fluid in some cases. At least partially spent variants of any of the foregoing treatment fluids may constitute the source of impure water in the disclosure herein. Treatment fluids formulated with liquid water produced in accordance with the disclosure herein may be suitably formulated by a person having ordinary skill in the art.

As used herein, the term “drilling operation” refers to the process of forming a wellbore in a subterranean formation. As used herein, the term “drilling fluid” refers to a fluid used in drilling a wellbore during a drilling operation.

As used herein, the term “stimulation operation” refers to an activity conducted within a wellbore to increase production therefrom. As used herein, the term “stimulation fluid” refers to a fluid used downhole during a stimulation operation to increase production of a hydrocarbon resource from a subterranean formation. In particular instances, stimulation fluids may include a fracturing fluid or an acidizing fluid.

As used herein, the terms “clean-up operation” or “damage control operation” refer to any operation for removing extraneous material from a wellbore to increase production. As used herein, the terms “clean-up fluid” or “damage control fluid” refer to a fluid used for removing an unwanted material from a wellbore that otherwise blocks or impedes flow of a desired fluid therethrough. In one example, a clean-up fluid can be an acidified fluid for removing material formed by one or more perforation treatments. In another example, a clean-up fluid can be used to remove a filter cake deposited upon the wellbore walls.

As used herein, the term “fracturing operation” refers to a high-pressure operation that creates or extends a plurality of flow channels within a subterranean formation. As used herein, the term “fracturing fluid” refers to a viscosified fluid used in conjunction with a fracturing operation.

As used herein, the term “remediation operation” refers to any operation designed to maintain, increase, or restore a specific rate of production from a wellbore, which may include stimulation operations or clean-up operations. As used herein, the term “remediation fluid” refers to any fluid used in conjunction with a remediation operation.

As used herein, the term “acidizing operation” refers to any operation designed to remove an acid-soluble material from a wellbore, particularly an acid-soluble material that comprises at least a portion of the subterranean formation. As used herein, the term “acidizing fluid” refers to a fluid used during an acidizing operation.

As used herein, the term “spotting fluid” refers to a fluid designed for localized treatment of a subterranean formation. In one example, a spotting fluid can include a lost circulation material for treatment of a specific section of the wellbore, such as to seal off fractures in the wellbore and prevent sag. In another example, a spotting fluid can include a water control material or material designed to free a stuck piece of drilling or extraction equipment.

As used herein, the term “completion fluid” refers to a fluid used during the completion phase of a wellbore, including cementing compositions and cementing fluids.

As used herein, the term “cementing fluid” refers to a fluid used during cementing operations within a wellbore penetrating a subterranean formation.

Any of the foregoing types of treatment fluids may be formulated with liquid water produced in accordance with the disclosure herein. Likewise, spent or partially spent variants of any of the foregoing types of treatment fluids may constitute at least a portion of the impure water undergoing purification according to the disclosure herein.

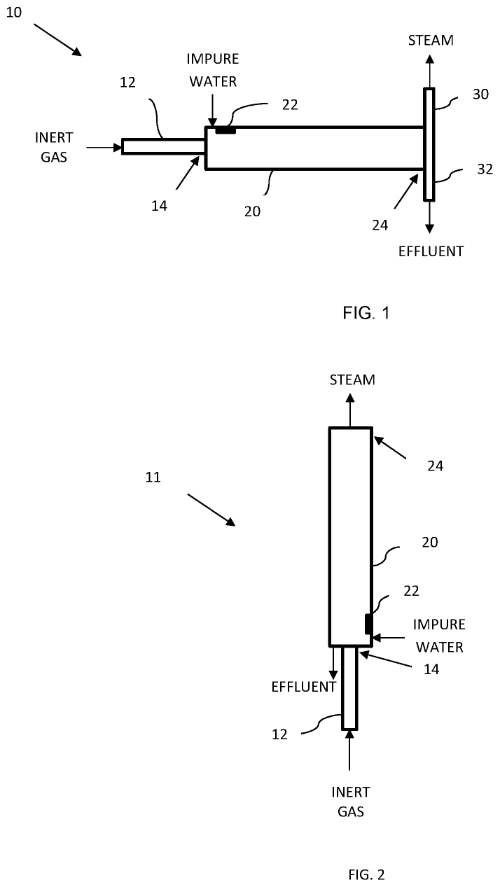

FIG. 1 shows a diagram of a water purification apparatus of the present disclosure, positioned in a substantially horizontal orientation. As shown, apparatus 10 includes shockwave nozzle 12 having exit end 14. A stream of inert gas enters shockwave nozzle 12 at a sub-sonic velocity at a location opposite to exit end 14 and undergoes acceleration to a supersonic velocity upon reaching exit end 14. For example, the supersonic velocity may be reached downstream of a pinch point within shockwave nozzle 12. Shockwave tube 20 is operably connected to exit end 14 and receives a supersonic gas stream from shockwave nozzle 12. Impure water may be introduced to shockwave tube 20 at or near the location where shockwave tube 20 is operably connected to exit end 14. Heater 22 may be positioned within shockwave tube 20 at a location downstream from the location where impure water enters. In non-limiting examples, heater 22 may comprise a burner flame or electric heating element.

Upon supplying impure water into the supersonic gas stream within shockwave tube 20, atomized water droplets are produced in the form of a standing fluid wave. Heat generated by heater 22 is conveyed into the standing fluid wave (e.g., assisted by the Venturi effect), which results in conversion of at least a portion of the atomized water droplets into steam. The steam is conveyed along the length of shockwave tube 20 toward exit end 24. The steam is separated from an effluent stream comprising one or more contaminants, which may collect upon a lower interior surface of shockwave tube 20 and also progress toward exit end 24. As shown, the steam may exit shockwave tube 20 as an overhead stream through chimney 30, and the effluent stream may exit through drain 32. Apparatus 10 may be deviate slightly from a true horizontal orientation, as discussed above, to facilitate drainage of the effluent stream from exit end 24. Optionally, chimney 30 and drain 32 may be omitted, such that steam and effluent drain as separate streams directly from an opening at exit end 24 of shockwave tube 20.

FIG. 2 shows a diagram of a water purification apparatus of the present disclosure, positioned in a substantially vertical orientation. Apparatus 11 bears many similarities to apparatus 10 (FIG. 1) in form and operation and may be better understood by reference thereto. Other than the substantially vertical orientation, the main difference between apparatus 11 and apparatus 10 is the location where effluent leaves shockwave tube 20. As shown in FIG. 2, steam is again produced in shockwave tube 20, progresses upward, and leaves via exit end 24. The effluent stream that is produced drains downward under the influence of gravity and countercurrent to the direction of steam production. The effluent stream may drain adjacent to the location where shockwave nozzle 12 and shockwave tube 20 are operably connected to each other. Apparatus 11 may deviate slightly from a true vertical orientation, if desired, so that the effluent stream drains away from heater 22 and/or does not occlude exit end 14 of shockwave nozzle 12.

Accordingly, apparatuses of the present disclosure may comprise a shockwave nozzle having an entry end and an exit end, a shockwave tube operably connected to the exit end of the shockwave nozzle, a gas inlet operably connected to the entry end of the shockwave nozzle, a liquid inlet operably connected to a downstream portion of the shockwave nozzle or to the shockwave tube, a heat source in thermal communication with an interior space of the shockwave tube, and an outlet configured to remove an overhead stream and an effluent stream from the shockwave tube. In particular apparatus configurations, the outlet may comprise a first fluid outlet configured to remove an overhead stream from the shockwave tube, and a second fluid outlet configured to remove an effluent stream from the shockwave tube. The overhead stream may be a vapor stream and the effluent stream may be a liquid stream in particular instances.

The shockwave tube may be oriented horizontally, vertically, or any orientation in between. When oriented horizontally or substantially horizontally, the shockwave tube may be oriented at true horizontal or within about −30 degrees of true horizontal (i.e., sloped downward toward an exit end of the shockwave nozzle). In a horizontal or substantially horizontal orientation, the outlet may comprise a first outlet configured to remove the overhead stream and a second outlet configured to remove the effluent stream, wherein the first outlet and the second outlet are located opposite the shockwave nozzle at one end of the shockwave tube. In a vertical or substantially vertical orientation, the shockwave tube may be oriented at true vertical or within about +/−30 degrees of true vertical, wherein the outlet may comprise a first outlet configured to remove the overhead stream and a second outlet configured to remove the effluent stream, and the first outlet and the second outlet are located at opposite ends of the shockwave tube. Specifically, the second outlet in a vertical or near-vertical orientation of the shockwave tube may be located adjacent to the location where the shockwave nozzle and the shockwave tube are operably connected to one another.

Suitable liquid inlets may be operably connected to the shockwave tube. The liquid inlet may be configured to provide a continuous fluid stream and located upstream from or concurrent with the heat source, as discussed above.

The heat source may be a burner flame or an electric heating element located within the shockwave tube. The heat source may be located concurrent with or downstream from the location of the liquid inlet.

Embodiments disclosed herein include:
A. Water purification methods: The methods comprise: generating a supersonic gas stream by feeding a gas through a shockwave nozzle under conditions sufficient to achieve a supersonic velocity; supplying impure water into the supersonic gas stream to produce a standing fluid wave comprising atomized water droplets downstream from an exit end of the shockwave nozzle; wherein the impure water contains one or more contaminants; introducing sufficient heat into the standing fluid wave to cause at least a portion of the atomized water droplets to phase change into steam; and obtaining the steam as an overhead stream separated from an effluent stream comprising at least a portion of the one or more contaminants.
B. Apparatuses for water purification. The apparatuses comprise: a shockwave nozzle having an entry end and an exit end; a shockwave tube operably connected to the exit end of the shockwave nozzle; a gas inlet operably connected to the entry end of the shockwave nozzle; a liquid inlet operably connected to a downstream portion of the shockwave nozzle or to the shockwave tube; a heat source in thermal communication with an interior space of the shockwave tube; and an outlet configured to remove an overhead stream and an effluent stream from the shockwave tube.

Embodiments A and B may have one or more of the following additional elements in any combination.
Element 1: wherein the supersonic gas stream comprises air, nitrogen, or any combination thereof.
Element 2: wherein the impure water is supplied as a continuous fluid stream.
Element 3: wherein heat is introduced into the standing fluid wave from a heat source positioned adjacent to the standing fluid wave.
Element 4: wherein the standing fluid wave is produced within a shockwave tube operably connected to the exit end of the shockwave nozzle.
Element 5: wherein the heat source is located within the shockwave tube and/or wherein heat is introduced into the standing fluid wave from a heat source located within the shockwave tube.
Element 6: wherein the impure water is supplied into the shockwave tube.
Element 7: wherein heat is introduced into the standing fluid wave from a burner flame projected into the standing fluid wave.
Element 8: wherein the burner flame is located adjacent to the exit end of the shockwave nozzle.
Element 9: wherein heat is introduced into the standing fluid wave from an electric heating element positioned adjacent to the standing fluid wave.
Element 10: wherein the impure water comprises a water selected from the group consisting of produced water, ground water, salt water, sea water, brine, brackish water, mining water, industrial waste water, municipal waste water, a spent or partially spent oilfield treatment fluid, gray water, black water, and any combination thereof.
Element 11: wherein the impure water comprises one or more organic contaminants, and at least a portion of the one or more organic contaminants are pyrolyzed upon introducing sufficient heat into the standing fluid wave.
Element 12: wherein the impure water comprises one or more inorganic contaminants, and at least a portion of the one or more inorganic contaminants are concentrated within the effluent stream.
Element 13: wherein the effluent stream comprises a liquid effluent stream.
Element 14: wherein the method further comprises collecting the steam, and optionally condensing the steam as liquid water.
Element 15: wherein the method further comprises condensing the steam as liquid water; and reintroducing the liquid water to the supersonic gas stream.
Element 16: wherein the method further comprises condensing the steam as liquid water; and supplying the liquid water to a parallel process in need thereof.
Element 17: wherein the impure water is obtained from the parallel process.
Element 18: wherein the parallel process comprises drilling a wellbore or producing a hydrocarbon resource from a wellbore.
Element 19: wherein the method further comprises supplying the steam to a parallel process in need thereof.
Element 20: wherein the shockwave tube is oriented horizontally or within about −30 degrees of true horizontal, and the outlet comprises a first outlet configured to remove the overhead stream and a second outlet configured to remove the effluent stream, the first outlet and the second outlet being located opposite the shockwave nozzle at one end of the shockwave tube.
Element 21: wherein the shockwave tube is oriented vertically or within about +/−30 degrees of true vertical, and the outlet comprises a first outlet configured to remove the overhead stream and a second outlet configured to remove the effluent stream, the first outlet and the second outlet being located at opposite ends of the shockwave tube.
Element 22: wherein the liquid inlet is configured to provide a continuous fluid stream.
Element 23: wherein the liquid inlet is operably connected to the shockwave tube.
Element 24: wherein the liquid inlet is located upstream from or concurrent with the heat source.
Element 25: wherein the heat source comprises a burner flame located within the shockwave tube.
Element 26: wherein the burner flame is located adjacent to the exit end of the shockwave nozzle.
Element 27: wherein the heat source comprises an electric heating element located within the shockwave tube.

By way of non-limiting example, exemplary combinations applicable to A include, but are not limited to, 1 and 2; 1 and 3; 1 and 4; 1, 3, 4 and 5; 1, 4 and 6; 1, 3, 4, 5 and 6; 1 and 7; 1, 3, 4 and 7; 1, 7 and 8; 1 and 8; 1 and 9; 1, 3, 4 and 9; 1, 3, 4, 5 and 9; 1 and 10; 1, 10 and 11; 1, 10, 11 and 12; 1, 10 and 12; 1 and 11; 1 and 12; and 1 and 13, any of which may be in further combination with 10; 10 and 11; 10-12; 10 and 12; 11; 12; 13; 10 and 13; 11 and 13; 12 and 13; and 10-13. Additional exemplary combinations applicable to A include, but are not limited to, 2 and 3; 2 and 4; 2, 3, 4 and 5; 2, 4 and 6; 2, 3, 4, 5 and 6; 2 and 7; 2, 3, 4 and 7; 2, 7 and 8; 2 and 8; 2 and 9; 2, 3, 4 and 9; 2, 3, 4, 5 and 9; 2 and 10; 2, 10 and 11; 2, 10, 11 and 12; 2, 10 and 12; 2 and 11; 2 and 12; and 2 and 13, any of which may be in further combination with 10; 10 and 11; 10-12; 10 and 12; 11; 12; 13; 10 and 13; 11 and 13; 12 and 13; and 10-13. Additional exemplary combinations applicable to A include, but are not limited to, 3 and 4; 3, 4 and 5; 3, 4 and 6; 3, 4, 5 and 6; 3, 4, 5 and 7; 3 and 7; 3, 4 and 7; 3, 7 and 8; 3, 4, 5, 7 and 8; 3 and 8; 3 and 9; 3, 4 and 9; 3, 4, 5 and 9; 3 and 10; 3, 10 and 11; 3, 10, 11 and 12; 3, 10 and 12; 3 and 11; 3 and 12; and 3 and 13, any of which may be in further combination with 10; 10 and 11; 10-12; 10 and 12; 11; 12; 13; 10 and 13; 11 and 13; 12 and 13; and 10-13. Additional exemplary combinations applicable to A include, but are not limited to, 4 and 6; 4 and 9; 4 and 10; 4, 10 and 11; 4, 10, 11 and 12; 4, 10 and 12; 4 and 11; 4 and 12; 4 and 13; 4, 10, 11, 12 and 13; 6 and 7; 6, 7 and 8; 6 and 9; 6 and 10; 6, 10 and 11; 6, 10, 11 and 12; 6, 10 and 12; 6 and 11; 6 and 12; 6 and 13; 6, 10, 11, 12 and 13; 7 and 8; 7 and 10; 7, 10 and 11; 7, 10, 11 and 12; 7, 10 and 12; 7 and 11; 7 and 12; 7 and 13; 7, 10, 11, 12 and 13; 9 and 10; 9, 10 and 11; 9, 10, 11 and 12; 9, 10 and 12; 9 and 11; 9 and 12; 9 and 13; 9, 10, 11, 12 and 13; 10 and 11; 10, 11 and 12; 10 and 12; and 10, 11, 12 and 13. Any of the foregoing may be in further combination with one or more of 14; 15; 16; 16 and 17; 18; or 19.

By way of non-limiting example, exemplary combinations applicable to B include, but are not limited to, 20 or 21, and 22; 20 or 21, and 23; 20 or 21, and 24; 20 or 21, 22 and 24; 20 or 21, and 22-24; 20 or 21, and 25; 20 or 21, 25 and 26; 20 or 21, and 27; 22 and 23; 22 and 24; 22-24; 22 and 25; 22, 25 and 26; 22 and 27; 23 and 24; 23 and 25; 23, 25 and 26; 23 and 27; 24 and 25; 24-26 and 24 and 27.

While forms of the disclosure have been illustrated and described, various modifications can be made without departing from the spirit and scope of the disclosure. Accordingly, it is not intended that the disclosure be limited thereby. All documents described herein are incorporated by reference herein for purposes of all jurisdictions where such practice is allowed, including any priority documents and/or testing procedures to the extent they are not inconsistent with the text herein.

Unless otherwise indicated, all numbers expressing quantities and the like in the present specification and associated claims are to be understood as being modified in all instances by the term “about.” Accordingly, unless indicated to the contrary, the numerical parameters set forth in the specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating various features are presented herein. Not all features of a physical implementation are described or shown in this application for the sake of clarity. It is understood that in the development of a physical embodiment incorporating the embodiments of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While various systems, apparatuses and methods of the present disclosure are described herein in terms of “comprising” various components or steps, the systems, apparatuses and methods can also “consist essentially of” or “consist of” the various components and steps.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Therefore, the disclosed systems, apparatuses and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems, apparatuses and methods illustratively disclosed herein may suitably be practiced in the absence of any element that is not specifically disclosed herein and/or any optional element disclosed herein. While systems, apparatuses and methods are described in terms of “comprising,” “containing,” or “including” various components or steps, the systems, apparatuses and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

1. A method comprising:
generating a supersonic gas stream by feeding a gas through a shockwave nozzle under conditions sufficient to achieve a supersonic velocity;
supplying impure water into the supersonic gas stream to produce a standing fluid wave comprising atomized water droplets downstream from an exit end of the shockwave nozzle;
wherein the impure water contains one or more contaminants;
introducing sufficient heat into the standing fluid wave to cause at least a portion of the atomized water droplets to phase change into steam; and
obtaining the steam as an overhead stream separated from an effluent stream comprising at least a portion of the one or more contaminants.

2. The method of claim 1, wherein the supersonic gas stream comprises air, nitrogen, or any combination thereof.

3. The method of claim 1, wherein the impure water is supplied as a continuous fluid stream.

4. The method of claim 1, wherein heat is introduced into the standing fluid wave from a heat source positioned adjacent to the standing fluid wave.

5. The method of claim 1, wherein the standing fluid wave is produced within a shockwave tube operably connected to the exit end of the shockwave nozzle.

6. The method of claim 5, wherein heat is introduced into the standing fluid wave from a heat source located within the shockwave tube.

7. The method of claim 5, wherein the impure water is supplied into the shockwave tube.

8. The method of claim 1, wherein heat is introduced into the standing fluid wave from a burner flame projected into the standing fluid wave.

9. The method of claim 8, wherein the burner flame is located adjacent to the exit end of the shockwave nozzle.

10. The method of claim 1, wherein heat is introduced into the standing fluid wave from an electric heating element positioned adjacent to the standing fluid wave.

11. The method of claim 1, wherein the impure water comprises a water selected from the group consisting of produced water, ground water, salt water, sea water, brine, brackish water, mining water, industrial waste water, municipal waste water, a spent or partially spent oilfield treatment fluid, gray water, black water, and any combination thereof.

12. The method claim 1, wherein the impure water comprises one or more organic contaminants, and at least a portion of the one or more organic contaminants are pyrolyzed upon introducing sufficient heat into the standing fluid wave.

13. The method claim 1, wherein the impure water comprises one or more inorganic contaminants, and at least a portion of the one or more inorganic contaminants are concentrated within the effluent stream.

14. The method of claim 14, wherein the effluent stream comprises a liquid effluent stream.

15. The method of claim 14, further comprising:
collecting the steam, and
optionally condensing the steam as liquid water.

16. The method of claim 14, further comprising:
condensing the steam as liquid water; and
reintroducing the liquid water to the supersonic gas stream.

17. The method of claim 14, further comprising:
condensing the steam as liquid water; and
supplying the liquid water to a parallel process in need thereof.

18. The method of claim 17, wherein the impure water is obtained from the parallel process.

19. The method of claim 17, wherein the parallel process comprises drilling a wellbore or producing a hydrocarbon resource from a wellbore.

20. The method of claim 14, further comprising:
supplying the steam to a parallel process in need thereof.

21. An apparatus comprising:
a shockwave nozzle having an entry end and an exit end;
a shockwave tube operably connected to the exit end of the shockwave nozzle;
a gas inlet operably connected to the entry end of the shockwave nozzle;
a liquid inlet operably connected to a downstream portion of the shockwave nozzle or to the shockwave tube;
a heat source in thermal communication with an interior space of the shockwave tube; and
an outlet configured to remove an overhead stream and an effluent stream from the shockwave tube.

22. The apparatus of claim 21, wherein the shockwave tube is oriented horizontally or within about −30 degrees of true horizontal, and the outlet comprises a first outlet configured to remove the overhead stream and a second outlet configured to remove the effluent stream, the first outlet and the second outlet being located opposite the shockwave nozzle at one end of the shockwave tube.

23. The apparatus of claim 21, wherein the shockwave tube is oriented vertically or within about +/−30 degrees of true vertical, and the outlet comprises a first outlet configured to remove the overhead stream and a second outlet configured to remove the effluent stream, the first outlet and the second outlet being located at opposite ends of the shockwave tube.

24. The apparatus of claim 21, wherein the liquid inlet is configured to provide a continuous fluid stream.

25. The apparatus of claim 21, wherein the liquid inlet is operably connected to the shockwave tube.

26. The apparatus of claim 21, wherein the liquid inlet is located upstream from or concurrent with the heat source.

27. The apparatus of claim 21, wherein the heat source comprises a burner flame located within the shockwave tube.

28. The apparatus of claim 27, wherein the burner flame is located adjacent to the exit end of the shockwave nozzle.

29. The apparatus of claim 21, wherein the heat source comprises an electric heating element located within the shockwave tube.
